(19) United States
(12) Patent Application Publication
(10) Pub. No.: US 2004/0203293 A1
(43) Pub. Date: Oct. 14, 2004

(54) Electrical contact with symmetric support means

(76) Inventor: Snower Hu, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/463,466

(22) Filed: Jun. 16, 2003

(30) Foreign Application Priority Data
Apr. 11, 2003 (TW) 92205664

(51) Int. Cl. H01R 13/42

(52) U.S. Cl. 439/751

(57) ABSTRACT

The electrical contact (1) comprises a retention portion (11), a mating portion (12) extending upwardly from the retention portion, and a tail portion (13) extending downwardly from the retention portion. The retention portion comprises two opposite main surfaces (110), and two opposite side surfaces (111) adjoining between the main surfaces. Each main surface defines an elongate support member (1101) at a center thereof. A pair of parallel, symmetric elongate first recesses (1102) is defined at opposite sides respectively of each support member. An elongate recess (1110) is defined in each side surface, the recesses enhancing a resiliency of the electrical contact.

### BACKGROUND OF THE INVENTION

1. Field of the Invention

The present invention relates to a contact for an electrical connector, and particularly to a contact for an electrical connector for being press fitted into a corresponding through hole in a PCB (Printed Circuit Board) on which the connector is mounted.

2. Description of Prior Art

Two methods are commonly used in the connector field for connecting contacts of an electrical connector to a PCB that defines a plurality of though holes for receiving the contacts therein. One method is to insert tail portions of the contacts into corresponding through holes of the PCB, and then solder the tail portions to the PCB. However, the soldering process is inconvenient and tedious. The other method is press-fitting the tail portions of the contacts into the corresponding through holes of the PCB. Press-fitting is more readily applied by manufacturers to facilitate quick assembly on mass production lines.

As illustrated in FIG. 5, a retention portion 61 of a conventional press-fitting type contact 6 for a connector 8 is formed by stamping a hole 611 in the pre-formed retention portion 61 of the contact 6. The hole 611 typically has a needle-eye shape, and a tail portion 63 is connected with the retention portion 61. By simply press fitting the retention portion 61 of the contact 6 into a corresponding through hole 71 of a PCB 7, an electrical connection can be established between the contact 6 and the PCB 7. During the press-fit engagement, the retention portion 61 of the contact 6 is compressed by inner sides 72 of the PCB 7 surrounding the through hole 71. The retention portion 61 is plastically deformed and securely engaged in the through hole 71.

However, one problem with this type of contact is that the hole 611 of the contact 6 inevitably reduces a strength of the retention portion 61. Usually a large insertion force is required to insert the retention portion 61 into the through hole 71 of the PCB 7. If the retention portion 61 of the contact 6 is weakened, it tends to deform to one side and cause the tail portion 63 to incline as shown in broken lines in FIG. 5. The inclined tail portion 63 is displaced from the correct position in where it is to be engaged with another contact (not shown). For example, the tail portion 63 of the contact 6 extends through the PCB 7, and is to be mated with a complementary connector (not shown). However, if the tail portion 63 is inclined, this is liable to cause failure of the electrical connection.

Therefore, an improved press-fit contact is required to overcome the aforesaid disadvantages of the prior art.

### SUMMARY OF THE INVENTION

Accordingly, an object of the present invention is to provide a press-fit electrical contact having sufficient strength to support a retention portion thereof and thereby prevent bending of the contact during the process of press fitting.

To achieve the above-mentioned object, an electrical contact for a connector with support means is provided by the present invention. The electrical contact comprises a retention portion, a mating portion extending upwardly from the retention portion, and a tail portion extending downwardly from the retention portion. The mating portion is adapted to be fixedly held in the connector. The retention portion is adapted to be inserted into a corresponding through hole of a PCB. The tail portion is adapted to extend through the through hole and mate with a corresponding contact of a complementary electrical connector.

The retention portion comprises two opposite main surfaces, and two opposite side surfaces adjoining between the main surfaces. Each main surface defines an elongate support member at a center thereof. A pair of parallel, symmetric elongate first recesses is defined at opposite sides respectively of each support member. An elongate recess is defined in each side surface, the recesses enhancing a resiliency of the electrical contact.

Other objects, advantages and novel features of the invention will become more apparent from the following detailed description when taken in conjunction with the accompanying drawings, in which:

### BRIEF DESCRIPTION OF THE DRAWINGS

FIG. 1 is an isometric view of an electrical contact in accordance with a preferred embodiment of the present invention;

FIG. 2 is a cross-sectional view taken along line II-II of FIG. 1;

FIG. 3 is a front plan view of the contact of FIG. 1 fixed in a connector and inserted into a corresponding through hole of a PCB, with the connector and the PCB being shown in cross-section;

FIG. 4 is a cross-sectional view taken along line IV-IV of FIG. 3; and

FIG. 5 is front plan view of a conventional press-fit contact fixed in a connector and inserted into a corresponding through hole of a PCB, with the connector and the PCB being shown in cross-section.

### DETAILED DESCRIPTION OF PREFERRED EMBODIMENT OF THE INVENTION

Reference will now be made to the drawings to describe the present invention in detail.

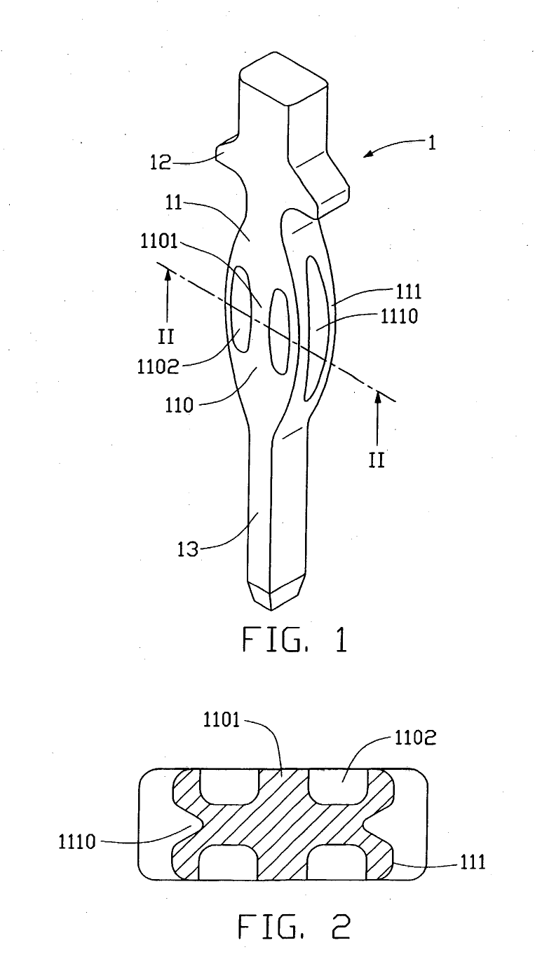

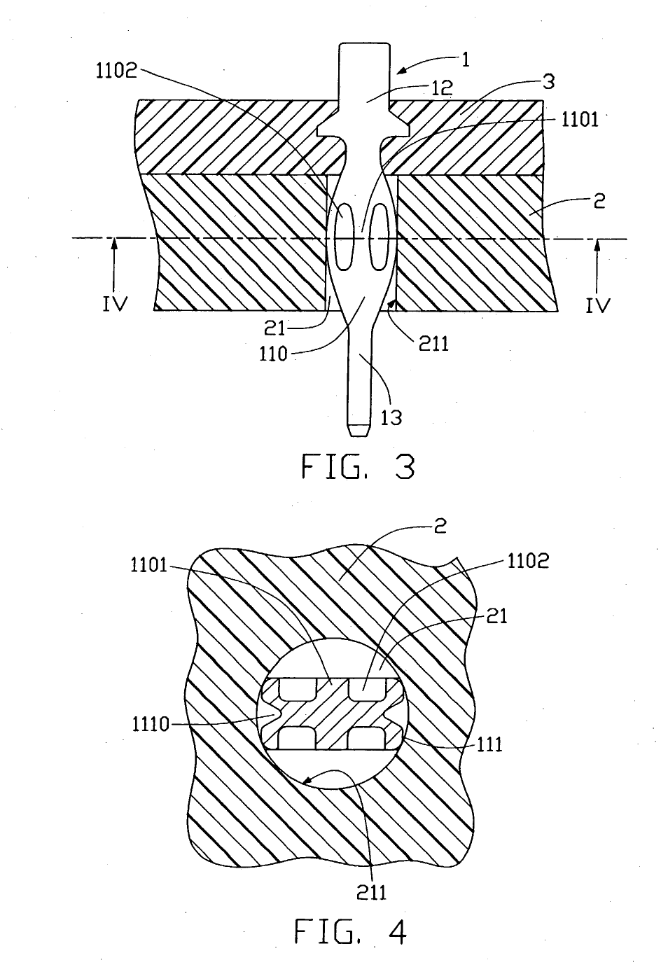

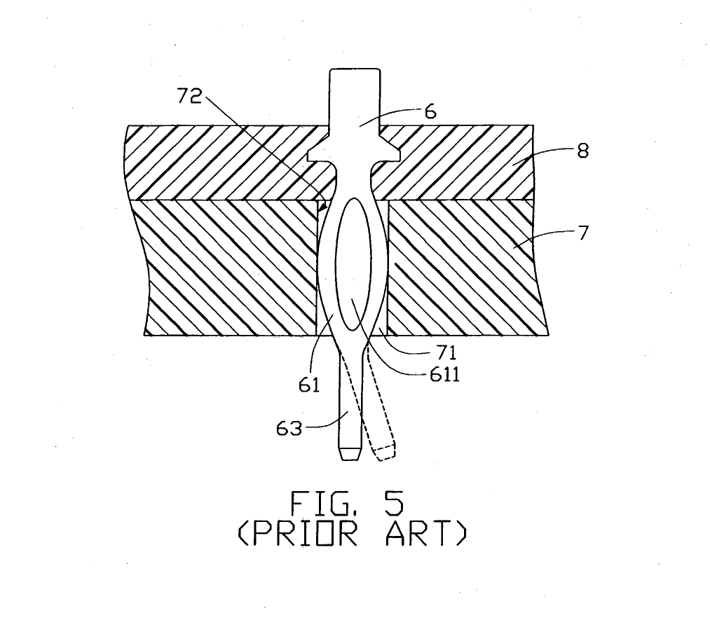

Referring to FIGS. 1-4, an electrical contact 1 in accordance with the present invention is for a connector 3 such as a backplane connector. The electrical contact 1 comprises a retention portion 11, a mating portion 12 extending upwardly from the retention portion 11, and a tail portion 13 extending downwardly from the retention portion 11. The mating portion 12 is adapted to be fixedly held in the connector 3. The retention portion 11 is adapted to be inserted into a corresponding through hole 21 of a PCB 2. The tail portion 13 is adapted to extend through the through hole 21 and mate with a corresponding contact of a complementary electrical connector (not shown).

The retention portion 11 is substantially a prolate flat plate which is broader than the tail portion 13. The retention portion 11 comprises two opposite main surfaces 110, and two opposite side surfaces 111 adjoining between the main surfaces 110. Each main surface 110 defines an elongate support member 101 at a center thereof. A pair of parallel, symmetric elongate first recesses 1102 is defined at opposite sides respectively of each support member 1101. An elongate recess 1110 is defined in each side surface 111, the recesses 1110 enhancing a resiliency of the electrical contact 1.

The electrical contact 1 is formed by stamping a metal strip, and the metal strip is ordinarily provided with a pilot hole by means of which the metal strip is fed through a die. When in the correct position, the metal strip is stamped to form the retention portion 11, the mating portion 12, the tail portion 13 and the first recesses 1102 in the main surfaces 110. The second recesses 1110 in the side surfaces 111 are also formed in this process, because of deformation of the main surfaces 110 relative to the side surfaces 11.

In use, the electrical contact 1 is inserted into the corresponding through hole 21 of the PCB 2. A diameter of the through hole 21 is less than a maximum transverse dimension of the retention portion 11. Therefore the side surfaces 111 of the electrical contact 1 deform and engage with a corresponding inner surface 211 of the PCB 2 bounding the through hole 21. Thus the retention portion 11 of the electrical contact 1 is secured in the through hole 21, with the tail portion 13 extending through the PCB 2 for mating with the corresponding contact of the complementary electrical connector.

The support members 1101 of the retention portion 11 provide ample strength for the retention portion 11. In addition, because the first recesses 1102 are configured symmetrically to each other, the electrical contact 1 can be inserted through the through hole 21 safely, without the tail portion 13 tending to incline to one side during the process of press fitting. Therefore the electrical contact 1 achieves reliable mechanical and electrical performance.

While a preferred embodiment in accordance with the present invention has been shown and described, equivalent modifications and changes known to persons skilled in the art according to the spirit of the present invention are considered within the scope of the present invention as defined in the appended claims.

1. A contact for an electrical connector, comprising:
a substantially arch-shaped retention portion for engaging with a printed circuit board;
a mating portion; and
a tail portion for extending through a through hole of printed circuit board;
wherein the mating portion and the tail portion respectively extends from opposite ends of the retention portion, the retention portion comprises two opposite main surfaces with a support member, and a plurality of first recess symmetrically defined at opposite sides of the support member in each main surface, and the retention portion comprises two opposite side surfaces with a second recess defined along the side surface respectively, the side surfaces resiliently deforming to engage with the printed circuit board; wherein
the retention portion is inserted into corresponding through hole of the printed circuit board, and the maximum transverse dimension of the retention portion is larger than the diameter of the through hole.

2 (canceled)

3 (canceled)

4 (canceled)

5. A contact for an electrical connector comprising a substantially arch-shaped retention portion for engaging with corresponding through hole of a PCB, the retention portion comprising two opposite main surfaces with support member thereof respectively, each side of the support member defining a first recess aligned with the support member; wherein the retention portion is inserted into corresponding through hole of the PCB, and the maximum transverse dimension of the retention portion is larger than the diameter of the through hole.

6 (canceled)

7 (canceled)

8 (canceled)

9 (canceled)

10 (canceled)

11 (canceled)

12. In combination,
an insulative housing of an electrical connector;
a printed circuit board on which said insulative housing is seated;
a through hole defined in said printed circuit board;
an conductive contact with an upper portion retainably embedded in the housing and a lower portion extending downwardly through said through hole,
said through hole defining a circular cross-section,
said contact including a sandglass-like cross-section with a long side and a short side thereof in said through hole, said sandglass-like cross-section defining not only a narrowed waist in a first direction along said long side but also at least one recess in a second direction perpendicular to said first direction and along said short side; wherein
said recess does not extend through said contact along said second direction; wherein
said contact defines a substantially arch-shaped retention portion along thereof a portion having said sandglass-like cross-section; wherein
said contact is compressed in said through hole along the said first direction.

13 (canceled)
